(19) United States
(12) Patent Application Publication
(10) Pub. No.: US 2017/0267954 A1
(43) Pub. Date: Sep. 21, 2017

(54) METHOD FOR PRODUCING LIQUID COMPOSITIONS INCLUDING A SURFACTANT AND HAVING A YIELD POINT

(71) Applicant: Henkel AG & Co. KGaA, Duesseldorf (DE)

(72) Inventors: Luca Bellomi, Duesseldorf (DE); Karl-Heinz Scheffler, Duesseldorf (DE); Nadine Langenscheidt-Dabringhausen, Baesweiler (DE); Martina Hutmacher, Duesseldorf (DE); Peter Schmiedel, Duesseldorf (DE); Gerd Boesemann, Duesseldorf (DE)

(73) Assignee: Henkel AG & Co. KGaA, Duesseldorf (DE)

(21) Appl. No.: 15/616,407

(22) Filed: Jun. 7, 2017

Related U.S. Application Data
(63) Continuation of application No. PCT/EP2015/078614, filed on Dec. 4, 2015.

(30) Foreign Application Priority Data
Dec. 8, 2014 (DE) 10 2014 225 145.1

(51) Int. Cl. C11D 17/00; C11D 1/66; C11D 1/29; C11D 11/00; C11D 1/22

(52) U.S. Cl. CPC C11D 17/0013; C11D 17/0039; C11D 11/0094; C11D 1/22; C11D 1/29; C11D 1/66

(57) ABSTRACT

The invention relates to a method for producing liquid compositions that have a yield point and contain one or more surfactants, in which a basic formulation comprising at least one surfactant and at least one solvent is produced in a batch process in a first step, and this basic formulation is differentiated in a continuous method in a subsequent second step. The invention also relates to the compositions obtained in this manner.

### FIELD OF THE INVENTION

The present invention generally relates to a method for producing liquid compositions having a yield point, comprising one or more surfactants, and to the compositions obtained therefrom.

### BACKGROUND OF THE INVENTION

Everyday life today is unimaginable without liquid, surfactant-containing compositions. These include body care products, such as shampoos, shower gels or bubble baths. However, they also cover washing or cleaning agents, such as household cleaners, softeners, laundry detergents, floor care agents, all-purpose cleaners, manual dishwashing agents, automatic dishwashing agents or general laundry detergents.

A majority of these compositions today is produced using a batch process. The batch process, often also referred to as batch production, is a discontinuous production method. In this process, certain amounts of charged substances are delivered into a container according to a predefined formulation, where they are mixed. The capacity of the production vessel, in which all components are mixed with one another, limits the amount of material produced in a batch.

In a typical batch process, initially a reaction vessel is loaded completely with the starting materials, these being the reactants. The reaction of the reactants with one another to yield the end product takes place inside the reaction vessel. Once the possibly occurring reaction is complete, the reaction vessel is completely emptied, and suitable containers are loaded with the desired formulation for sale or optionally for storage. Thereafter, the reaction vessel must be prepared for the next bottling. This involves thorough cleaning of the reaction vessel, and optionally of the lines via which the starting products are introduced into the reaction vessel, and completion of required maintenance work.

Such a batch process has the advantage that the formula of the recipe can still be adjusted in the reaction vessel, if needed. It is possible to subsequently dose individual components. From quality points of view, it must be taken into consideration that the option of batch tracing exists in this regard.

The disadvantage, however, is the large space requirement. A reaction vessel is always loaded completely, which is to say large amounts of a product are always produced. Once a batch has been produced, it must first be processed, before another batch can be started. If direct further processing or bottling is not possible, a product that has already been produced must be stored outside the reaction vessel. This as well again results in a high space requirement, and additional costs are incurred.

Moreover, switching production from one product to another is very laborious. If, for example, a product which comprises a certain dye and a certain odorant is produced in a first batch process, the reaction vessel and all feed lines must first be thoroughly^{,} cleaned before a second product having a different dye and odorant profile is produced so as to avoid contamination of the batches.

In addition to the discontinuous batch process, continuous methods for producing liquid, surfactant-containing compositions are known. Continuous processes provide better options for just-in-time production. However, complex control of the individual process steps is necessary. In the continuous process, mixing by way of static or dynamic mixing devices does not take place in a reaction vessel as is the case in the batch process. Mixing rather takes place inside the line. The individual ingredients of a formulation are dosed into this line in a predefined sequence. Bottling takes place directly at the end of this line. Subsequent dosing or changing the concentrations of individual components is not possible here. It is necessary to monitor the addition of each individual component in a targeted and controlled manner.

Care must also be taken when producing body care, washing or cleaning agents that it may be necessary to add solid components. These, however, can only be added to a batch process. It is not possible to add solid components to a continuous process. Only liquid components can be dosed into continuous processes.

The addition of solid additives to corresponding compositions, however, forms the state of the art today. Stably suspending solids in liquids is frequently problematic, and in particular when the solids differ from the liquid with respect to density, these tend to either settle or float. The incorporation of certain active ingredients (such as bleaching agents, enzymes, perfumes, dyes and the like) into liquid washing and cleaning agents can also result in problems. It is possible for incompatibilities to occur between the individual active ingredient components of the liquid washing and cleaning agents, for example. This can result in undesirable discoloration, agglomeration, odor problems and destruction of active detergent ingredients.

Consumers, however, demand liquid washing and cleaning agents that optimally develop their effect at the time of use even after storage and transport. This requires that the ingredients of the liquid washing and cleaning agent have neither settled nor decomposed nor volatilized beforehand. One concept for incorporating sensitive, chemically or physically incompatible and volatile components is to use particles, and in particular microcapsules, in which these ingredients are enclosed in a storage-stable and transport-stable manner.

So as to generate a stable network in body care, washing or cleaning agents, in which solids can be stably suspended, what are known as structuring agents are frequently used, which are usually mixed together after the remaining components of the formulation, such as surfactants, solvents or builders, have been activated, whereby a structured product is obtained by generating a yield point. Such external structuring can be achieved, for example, by using structuring gums, such as xanthan gum, guar gum, locust bean gum, gellan gum, Weller gum or carrageenan, or polyacrylate thickeners. For aesthetic reasons, it is desirable for the agents to be transparent or at least translucent. The use of structuring gums, however, frequently results in cloudy compositions.

WO 0036078 describes transparent/translucent liquid washing agents capable of suspending particles having a size of 300 to 5000 μm, comprising at least 15% by weight surfactant and 0.01 to 5% by weight of a polymeric gum. The application does not include any information as to whether the liquid washing agents have yield points.

A further disadvantage when using these structuring or thickening agents is the sensitivity thereof with respect to ionic compounds, and in particular with respect to the anionic surfactants, which are inevitable in cleaning applications.

When high concentrations of polymeric thickeners are present in systems that, at the same time, have high concentrations of anionic surfactants, drastic increases in viscosity may result, which significantly impair the handling of the washing and cleaning agents (such as pumping, pouring or dosing). It is also not possible all the time to generate yield points in electrolyte-rich and/or surfactant-rich systems.

In other instances, yield points can be achieved by the formation of a lamellar structure of the surfactants. Certain amounts of surfactants, co-surfactants and inorganic salts are mixed with one another for this purpose, so as to alter the originally micellar structure of the surfactants into a lamellar structure by way of the co-surfactants and salts. Corresponding structuring agents are described in detail in WO 2013064357 A1, for example.

EP 1466959 A1 describes formulations having yield points and comprising high amounts of anionic surfactants, which do not comprise a polymeric thickener, but anionic and cationic surfactants in a certain ratio effective for generating a yield point.

When appropriate structuring agents having a yield point are produced in a discontinuous batch process, the production process is associated with the entrainment of air into the composition to be produced. This is disadvantageous since fluctuations in the density resulting from variable air entrainment make reproducible and constant bottling considerably more difficult, if not impossible. Moreover, the possibility exists that the air bubbles begin to float at low yield points, causing the composition to separate.

So as to achieve a stable structured product having a yield point, in which it is also possible to homogeneously suspend solids, it would therefore be desirable to provide a method in which the entrainment of air can be avoided. A solution in this regard is proposed in WO 2011056953 A1 and in WO 2011056947 A1. Here, the product is produced in a discontinuous process in the conventional manner and subsequently degassed. Alternatively, the resulting product could be deaerated in a centrifuge. Both methods, however, increase the apparatus-related complexity of the production process. Additionally, the required equipment is cost-intensive, and the production flexibility and capacity are adversely affected. Furthermore, not all components present in a liquid composition are so stable that these are stable with respect to a deaeration process under vacuum or with respect to the centrifugal forces that occur in a centrifuging process, whereby in particular the new or further development of formulations is made more difficult.

A need therefore exists for the provision of a method by way of which liquid surfactant-containing compositions having a yield point can be produced. In the method, no air, or as little air as possible, should be entrained into the composition. It should be possible to use not only liquid, but also solid starting materials as reactants.

According to the definition of the invention, a substance, such as a composition, is solid if it is present in the solid state of aggregation at 25° C. and 1013 mbar.

According to the definition of the invention, a substance, such as a composition, is liquid if it is present in the liquid state of aggregation at 25° C. and 1013 mbar. Liquid shall also cover gel-like.

Accordingly, it is desirable to provide an improved method for preparing a stable surfactant-containing liquid composition having a yield point. In addition, it is desirable that such composition is air-free or substantially air-free without being degassed at the end of the process. Furthermore, other desirable features and characteristics of the present invention will become apparent from the subsequent detailed description of the invention and the appended claims, taken in conjunction with this background of the invention.

### BRIEF SUMMARY OF THE INVENTION

The object underlying the present invention is thus achieved by a method for producing a liquid, surfactant-containing composition having a yield point, in which a base recipe, comprising at least one surfactant and at least one solvent, is produced in a first step in a batch process, and this base recipe is differentiated in a subsequent second step in a continuous process.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Surprisingly, it was found that an approximately air-free production method, in which both liquid and solid starting materials can be used, can be implemented by producing a base recipe in a first step in a batch process, which is then differentiated in a second step.

According to the invention, the composition has a yield point. In rheology, the yield point is understood to mean the shear stress (in Pa) below which a sample exclusively or at least substantially elastically deforms, and above which irreversible, plastic deformation, which is to say flowing, takes place.

The yield point of the liquid, surfactant-containing composition is measured by way of a rotational rheometer measuring in absolute terms from TA-Instruments, type AR G2 (shear stress controlled rheometer, cone-plate measuring system having a diameter of 40 mm, 2° cone angle, 20° C.). This is what is known as a shear stress-controlled rheometer. In the rheometer, the samples are subjected to rising shear stress σ(t) over time. For example, the shear stress can be increased over the course of 30 minutes from the smallest possible value (such as 0.01 Pa) to 100 Pa, for example. The deformation γ of the sample is measured as a function of this shear stress. The deformation is plotted in a log-log plot against the shear stress (log γ against log σ). If the analyzed sample has a yield point, this can be detected based on an abrupt change in the curve. Purely elastic deformation is found below a certain shear stress level. The slope of the curve γ(σ) (log-log plot) in this area is one. Above this shear stress, viscous flowing sets in, and the slope of the curve is suddenly higher. The shear stress at which the curve bends, which is to say the transition from elastic to plastic deformation, marks the yield point. The yield point (=bend in the curve) can be conveniently determined by applying tangents to the two curve sections. Samples without a yield point do not exhibit the characteristic bend in the function γ(σ).

The composition according to the invention preferably has a yield point in the range of 0.01 Pa to 50 Pa, preferably of 0.1 to 10 Pa, and particularly preferably of 0.5 Pa to 5 Pa. Compositions that have a maximum yield point of 10 Pa are particularly preferred. These can be bottled particularly well, and can be dosed well by the consumer.

According to the invention, the base recipe comprises at least one surfactant and at least one solvent. The base recipe can thus comprise one or more surfactants. These surfactants are selected from the group consisting of anionic, cationic, zwitterionic, non-ionic surfactants and the mixtures thereof. If the composition comprises multiple surfactants, these may be several different non-ionic surfactants, for example. However, it is also possible for the composition to comprise both non-ionic and anionic surfactants, for example. The same applies analogously to the other surfactants. The base recipe comprises at least one anionic surfactant and at least one non-ionic surfactant,

The content of surfactant in the final composition is preferably 0.1 to 40% by weight, more preferably 5 to 30% by weight, and still more preferably 10 to 25% by weight.

If the base recipe comprises an anionic surfactant, this is preferably selected from the group consisting of C₉₋₁₃ alkylbenzene sulfonates, olefin sulfonates, C₁₂₋₁₈ alkane sulfonates, ester sulfonates, alk(en)yl sulfates, fatty alcohol ether sulfates and mixtures thereof. It has been shown that these sulfonate and sulfate surfactants are particularly well-suited for producing stable liquid compositions having a yield point. Liquid compositions that comprise C₉₋₁₃ alkylbenzene sulfonates and fatty alcohol ether sulfates as the anionic surfactant have particularly good, dispersing properties. Surfactants of the sulfonate type that can be used are preferably C₉-C₁₃ alkylbenzene sulfonates, olefin sulfonates, which is to say mixtures of alkene and hydroxyalkane sulfonates, and disulfonates, as they are obtained, for example, from C₁₂-C₁₈ monoolefins having a terminal or internal double bond by way of sulfonation with gaseous sulfur trioxide and subsequent alkaline or acid hydrolysis of the sulfonation products. Also suitable are C₁₂₋₁₈ alkane sulfonates and the esters of α-sulfofatty acids (ester sulfonates), for example the α-sulfonated methyl esters of hydrogenated coconut, palm kernel or tallow fatty acids.

The alkali salts, and in particular the sodium salts of the sulfuric acid half-esters of C₁₂ to C₁₈ fatty alcohols, for example from coconut fatty alcohol, tallow fatty alcohol, lauryl, myristyl, cetyl or stearyl alcohol, or of C₁₀ to C₂₀ oxo alcohols and the half-esters of secondary alcohols having this chain length are preferred alk(en)yl sulfates. From a washing perspective, the C₁₂ to C₁₆ alkyl sulfates, C₁₂ to C₁₅ alkyl sulfates, and C₁₄ to C₁₅ alkyl sulfates are preferred. 2,3-alkyl sulfates are also suitable anionic surfactants.

Fatty alcohol ether sulfates, such as the sulfuric acid monoesters of straight-chain or branched C₇₋₂₁ alcohols ethoxylated with 1 to 6 moles of ethylene oxide, such as 2-methyl-branched. C₉₋₁₁ alcohols having, on average, 3.5 moles ethylene oxide (EO) or C₁₂₋₁₈ fatty alcohols having 1 to 4 EO, are also suited.

It is preferred that the liquid composition according to the invention comprises a mixture of sulfonate and sulfate surfactants. In a particularly preferred embodiment, the liquid composition comprises C₉-C₁₃ alkylbenzene sulfonates and fatty alcohol ether sulfates as the anionic surfactant.

In addition to the anionic surfactant, the liquid composition can also comprise soaps in the base recipe. Saturated and unsaturated fatty acid soaps are suitable, such as the salts of lauric acid, myristic acid, palmitic acid, stearic acid, (hydrogenated) erucic acid and behenic acid, and in particular soap mixtures derived from natural fatty acids, such as coconut oil, palm kernel oil, olive oil, or tallow fatty acids.

The anionic surfactants and the soaps may be present in the form of the sodium, potassium, magnesium or ammonium salts thereof. The anionic surfactants are preferably present in the form of the sodium salts thereof. Further preferred counterions for the anionic surfactants are also the protonated forms of choline, triethylamine, monoethanolamine or methylethylamine.

In addition to the anionic surfactant, the base recipe can also comprise at least one non-ionic surfactant. The non-ionic surfactant includes alkoxylated fatty alcohols, alkoxylated fatty acid alkyl esters, fatty acid amides, alkoxylated fatty acid amides, polyhydroxy fatty acid amides, alkylphenol polyglycol ethers, amine oxides, alkylpolyglucosides and mixtures thereof.

Alkoxylated, advantageously ethoxylated, in particular primary alcohols having preferably 8 to 18 carbon atoms and on average 4 to 12 moles ethylene oxide (EO) per mole of alcohol, in which the alcohol residue can be linear or preferably methyl-branched at the 2-position or can comprise linear and methyl-branched residues in the mixture, such as those usually present in oxo alcohol groups, are preferred as the non-ionic surfactant. However, in particular, alcohol ethoxylates comprising linear groups of alcohols of native origin having 12 to 18 carbon atoms, for example of coconut, palm, tallow fatty or oleyl alcohol, and an average of 5 to 8 EO per mole of alcohol are preferred. The preferred ethoxylated alcohols include, for example, C₁₂₋₁₄ alcohols having 4 EO or 7 EO, C₉₋₁₁ alcohol having 7 EO, C₁₃₋₁₅ alcohols having 5 EO, 7 EO or 8 EO, C₁₂₋₁₈ alcohols having 5 EO or 7 EO, and mixtures thereof. The degrees of ethoxylation indicated represent statistical averages that can correspond to an integer or a fractional number for a specific product. Preferred alcohol ethoxylates exhibit a restricted distribution of homologs (narrow range ethoxylates, NRE). In addition to these non-ionic surfactants, fatty alcohols having more than 12 EO can also be used. Examples of these are tallow fatty alcohol having 14 EO, 25 EO, 30 EO, or 40 EO. According to the invention, it is also possible to use non-ionic surfactants that have EO and PO groups in the molecule. Also suitable is a mixture of a (more strongly) branched ethoxylated fatty alcohol and an unbranched ethoxylated fatty alcohol, such as a mixture of a C₁₆₋₁₈ fatty alcohol having 7 EO and 2-propylheptanol having 7 EO. The washing, cleaning, after-treatment or auxiliary washing agent particularly preferably comprises a C₁₂₋₁₈ fatty alcohol having 7 EO or a C₁₃₋₁₅ oxo alcohol having 7 EO as the non-ionic surfactant.

The composition produced according to the invention furthermore comprises one or more solvents in the base recipe thereof. This may be water and/or non-aqueous solvents. The primary solvent in the base recipe is preferably water. The base recipe can furthermore comprise non-aqueous solvents. Suitable non-aqueous solvents include monohydric or polyhydric alcohols, alkanolamines or glycol ethers. The solvents are preferably selected from ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxy butanol, propylene glycol t-butyl ether, di-n-octyl ether, and mixtures of these solvents.

In the first step of the method according to the invention, a base recipe is produced in a conventional batch process which, in particular, has a viscosity of 1000 mPa·s or less, in particular 200 to 800 mPa·, and especially 400 to 700 mPa·s. The viscosity is determined at a temperature of 20° C. (HATDV II viscometer from Brookfield, 20 rpm spindle 2). Air is added to the base recipe in the batch process. Due to the lower viscosity, however, this air is able to escape from the base recipe within a very short time without any intervention, so that ultimately a product that is approximately free from air is obtained.

In addition to the at least one surfactant and the at least one solvent, the base recipe can furthermore comprise builders and/or alkaline substances. For example, polymeric polycarboxylates are suitable builders. These are, for example, the alkali metal salts of polyacrylic acid or of polymethacrylic acid, for example those having a relative molar mass from 600 to 750,000 g/mol.

Suitable polymers are in particular polyacrylates, which preferably have a molar mass from 1,000 to 15,000 g/mol. Due to the superior solubility thereof, short-chain polyacrylates having molar masses from 1,000 to 10,000 g/mol, and particularly preferably from 1,000 to 5,000 g/mol, may in turn be preferred from this group.

Also suitable are copolymeric polycarboxylates, in particular those of acrylic acid with methacrylic acid, and of acrylic acid or methacrylic acid with maleic acid. To improve the water solubility, the polymers can also contain allyl sulfonic acids, such as allyloxybenzene sulfonic acid and me hallyl sulfonic acid, as a monomer.

In particular silicates, aluminum silicates (in particular zeolites), carbonates, salts of organic dicarboxylic and polycarboxylic acids, and mixtures of these substances, shall also be mentioned as builders that may be present in the composition according to the invention.

Organic builders that may furthermore be present in the composition according furthermore to the invention are, for example, the polycarboxylic acids that can be used in the form of the sodium salts thereof, wherein polycarboxylic acids shall be understood to mean those carboxylic acids which carry more than one acid function. These include, for example, citric acid, adipic acid, succinic acid, glutaric acid, malic acid, tartaric acid, maleic acid, fumaric acid, saccharic acids, aminocarboxylic acids, nitrilotriacetic acid (NTA), methylglycinediacetic acid (MGDA) and the derivatives and mixtures thereof. Preferred salts are the salts of polycarboxylic acids such as citric acid, adipic acid, succinic acid, glutaric acid, tartaric acid, saccharic acids, and mixtures thereof.

Soluble builders, such as citric acid, or acrylic polymers having a molar mass of 1,000 to 5,000 g/mol, however, are preferred in the base recipe.

Alkaline substances or washing alkalis within the meaning of the present invention are chemicals to raise and stabilize the pH value of the composition.

In particular, preferably those components of the composition are added to the base recipe in the batch process which can be dosed exclusively in a discontinuous process. These are in particular components that are exclusively present in solid form and thus cannot be introduced into a composition in a continuous process. This applies to citric acid and the salts thereof, for example, such as sodium citrate, or boric acid. These must be introduced in the form of a solution or suspension.

According to the invention, a differentiation of the base recipe is then carried out in a second step following the first step. This takes place in a continuous process. It is thus possible to transfer the base recipe obtained in the first step directly into a continuous process. However, it is also possible to initially store the base recipe and use it in the continuous process only when needed.

Differentiation within the meaning of the present invention means that a base recipe, which is the same for several different liquid, surfactant-containing compositions, is differentiated to yield the actual desired end product. In this second step, only those substances are dosed to the base recipe which are important for the characteristics of the end product that is later obtained, which is to say the liquid, surfactant-containing composition produced according to the invention, such as dyes, perfume compositions, enzyme dyes, perfume capsules, microbeads, opacifying agents, dye transfer inhibitors (DTI), brighteners, salt solutions, co-surfactants or water.

The continuous method is characterized in that an overpressure is present inside the system in which the continuous method is carried out. The base recipe is conducted through a system of lines. Using pumps, the flow velocity of the composition, and thus also the pressure in the line system, is controlled. Pressure sensors attached to the line system allow the pressure inside the line system to be checked via feedback to the pumps. For example, pressure sensors from Endress and Hauser, Germany, are used. The line into which the base recipe is conducted is referred to as the main stream. The further components are dosed into this line to differentiate the base recipe. The continuous process under overpressure allows gas/air entrainment into the composition to be avoided. The continuous process is preferably carried out at a pressure which is elevated above ambient pressure by 0.1 to 6 bar, and in particular by 0.5 to 4 bar.

In this continuous process, all substances in liquid form are dosed together into a line in a continuous system and are homogenized by way of dynamic and/or static mixers. Since these can only be operated with liquid substances, it is only possible to use liquid products in the second step according to the invention for differentiation of the base recipe. Liquid products within the meaning of the present invention are liquids or solutions of solids in a suitable solvent, as well as stable suspensions, dispersions or emulsions.

The differentiation takes place along the main stream through which the base recipe flows. Compositions to be dosed may be premixed and dosed together into the main stream, or may be dosed individually or in different combinations, such as of 2 or 3 components, into the main stream via separate feed lines. Preferably, a mixer, and in particular a static mixer, is located at the site at which the dosing into the main stream takes place, ensuring fast and homogeneous distribution of the dosed agents in the main stream. It is possible, for example, to dose dyes, microcapsules and perfume into the stream separately from one another. From the point of view of feeding of the base recipe, initially the perfume can thus be dosed, and the dye can be dosed in a downstream step. However, the order of dosing may also take place in reverse, which is to say first the dye and then the perfume. In principle, it is preferable to dose those substances last which even in small quantities alter the base recipe. If, for example, a dye is first dosed into the base recipe and the perfume or another substance is not dosed until a later step, the path that the dye travels through the system is long, whereby the cleaning effort is considerably higher when the recipe changes so as to remove even the last traces of dye. It may thus be advantageous to dose dyes last into the main stream so as to allow rapid and favorable changing of the dye. The site of dosing perfume should also be determined in this regard. For the consumer, however, the visual perception plays a more important role than odor-specific aspects, so that, in case of doubt, the dye should be dosed after the perfume to avoid that the consumer notices unintended product discolorations stemming from a change in recipe.

According to the invention, the differentiation is carried out in particular by adding one or more co-surfactants and/or one or more electrolytes. The micellar structure of the surfactants in the base recipe is altered by the co-surfactant or the co-surfactants. This effect may be intensified by one or more electrolytes. As a result, a lamellar structure of the surfactants is created. Corresponding structured washing or cleaning agents having a yield point are described in the prior art in WO 2013064357 A1, for example. The entire content of this application is hereby incorporated by reference.

Co-surfactants within the meaning of the present invention are amphiphilic molecules comprising small, hydrophilic head groups. In a binary system with water, these co-surfactants are often only poorly soluble, or not soluble at all. As a result, these do not form any micelles. In the presence of the surfactants of the base recipe, the co-surfactants are introduced into the associates of the surfactants, thereby altering the morphology of these associates. Ball-like micelles become rod- and/or disk-shaped micelles. If the overall surfactant content is sufficiently high, lamellar phases or structures are formed.

The co-surfactant is preferably selected from the group consisting of alkoxylated C₈-C₁₈ fatty alcohols having a degree of alkoxylation of ≦3, aliphatic C₆-C₁₄ alcohols, aromatic C₈-C₁₄ alcohols, aliphatic C₆-C₁₂ dialcohols, monoglycerides of C₁₂-C₁₈ fatty acids, mono-glycerol ethers of C₈-C₁₈ fatty alcohols, and mixtures thereof. Further suitable co-surfactants are 1-hexanol, 1-heptanol, 1-octanol, 1,2-octanediol, stearin mono-glycerol and mixtures thereof.

Likewise, scent alcohols, such as geraniol, nerol, citronellol, linalool, rhodinol and other terpene alcohols, or scent aldehydes such as lilial or decanal are suitable co-surfactants.

Preferred co-surfactants are C₁₂-C₁₈ fatty alcohols having a degree of alkoxylation of ≦3. These co-surfactants are introduced particularly well into the preferred associates of anionic and non-ionic surfactants.

Suitable alkoxylated C₁₂-C₁₈ fatty alcohols having a degree of alkoxylation of ≦3 comprise, for example, i-C₁₃H₂₇O(CH₂CH₂O)₂H, i-C₁₃H₂₇O(CH₂CH₂O)3H, C₁₂₋₁₄ alcohol having 2 EO, C₁₂₋₁₄ alcohol having EO, C₁₃₋₁₅ alcohol having 3 EO, C₁₂₋₁₈ alcohols having 2 EO, and C₁₂₋₁₈ alcohols having 3 EO.

An electrolyte within the meaning of the present invention is an inorganic salt. Preferred inorganic salts include sodium chloride, potassium chloride, sodium sulfate, sodium carbonate, potassium sulfate, potassium carbonate, sodium hydrogen carbonate, potassium hydrogen carbonate, calcium chloride, magnesium chloride and mixtures thereof. Particularly stable compositions are obtained when sodium chloride or mixtures of sodium chloride and potassium sulfate are used.

Adding the inorganic salt supports the formation of lamellar structures. In addition, the inorganic salt influences the viscosity, so that it is possible to set the viscosity of the liquid composition with the aid of the inorganic salt.

It is particularly advantageous to produce the lamellar structure liquids in accordance with the method according to the invention, since, due to the low gas/air content in the liquid composition, lower amounts of surfactant and/or electrolyte suffice for forming lamellar structures that stabilize visually perceptible particles. The methods according to the related art require a considerably higher surfactant and/or electrolyte concentration to stabilize the air, and thus also the optical particles in the individual structured layers. At the same surfactant and/or electrolyte concentration compared to the compositions produced according to the invention, the compositions produced in accordance with methods according to the state of the art are therefore not able to stabilize the gas/air entrainment in the compositions, or are not able to stabilize the gas/air entrainment in the compositions to the same degree, so that the lamellar structure is at least partially destroyed by the buoyancy of the gas bubbles, and components present in the individual layers become mixed with one another. In particular, optical particles can deposit on the gas bubbles and float together with these. This makes it difficult to evenly distribute optional particles in the composition.

The yield point is preferably generated by dosing the co-surfactants and/or one or more electrolytes in the continuous process. This has the advantage that the components dosed in the continuous process are directly present in the desired lamellar structure. In particular, the content of co-surfactants and/or electrolytes in the final liquid, surfactant-containing composition having a yield point is up to 15% by weight, preferably up to 10% by weight, and still more preferably up to 5% by weight.

Furthermore, dispersed particles are preferably added to the base recipe in the second step for differentiation. Dispersed particles within the meaning of the present invention are not soluble in the solvent of the base recipe. They can, however, be dispersed therein. The method according to the invention allows a homogeneous distribution and stable dispersion of these particles. According to the invention, these dispersed particles may be functional and/or have an aesthetic function. Functional materials influence the action of the composition, while aesthetic materials only influence the appearance or the scent. The dispersed particles are preferably visible particles. This means that the particles are clearly apparent to the consumer in the composition (in the end product) and distinguishable from the remaining components. Preferably, this refers to dyed particles. These particles impart a particular impression to the composition, which consumers appreciate. The composition can particularly preferably include a dissolved dye, and additionally colored particles, which have a color that represents a contrast to the dissolved dye.

Functional dispersed particles within the meaning of the present invention can be capsules, abrasives, granules or compounds. The term capsule shall be understood to mean aggregates having a core-shell structure on the one hand, and aggregates having a matrix on the other hand. Core-shell capsules (microcapsules, microbeads) comprise at least one solid or liquid core, which is enclosed by at least one continuous shell, and in particular a shell made of polymer(s).

Sensitive, chemically or physically incompatible and volatile components (=active ingredients) of the liquid composition may be enclosed inside the capsules in a storage-stable and transport-stable manner. The capsules may contain, for example, optical brighteners, surfactants, complexing agents, bleaching agents, bleach activators, bleach catalysts, dyes and fragrances, antioxidants, builders, enzymes, enzyme stabilizers, antimicrobial active ingredients, graying inhibitors, antiredeposition agents, pH-setting agents, electrolytes, washing power boosters, vitamins, proteins, suds suppressors and/or UV absorbers. The fillings of the capsules can be solids or liquids in the form of solutions or emulsions or suspensions.

The dispersed particles can have a density that corresponds to that of the liquid composition. According to the invention, this means that the density of the dispersed particles corresponds to 90% to 110% of the composition. However, it is also possible for the dispersed particles to have a different density. Based on the method according to the invention, it is nonetheless possible to achieve uniform dispersion of the particles in the composition. These can include different materials, such as alginates, gelatin, cellulose, agar, waxes or polyethylenes. Particles that do not have a core-shell structure may also comprise an active ingredient in a matrix made of a matrix-forming material. These particles are referred to as “speckles.” The matrix formation in the case of these materials takes place by way of gelling, polyanion-polycation interaction or polyelectrolyte-metal ion interaction, for example, and is well-known in the prior art, as is the production of particles with these matrix-forming materials.

In a further embodiment of the present invention, the object is achieved by a liquid, surfactant-containing composition having a yield point, which is obtained by way of the method according to the invention. The final composition preferably has a yield point of 0.01 Pa to 50 Pa, preferably of 0.1 to 10 Pa, and particularly preferably of 0.5 Pa to 5 Pa. The composition is in particular characterized by having a viscosity, measured at 20° C., of 50,000 mPa·s or less, and in particular 3000 mPa·s or less. The compositions according to the invention differ from the known compositions with respect to the lower gas/air content thereof, and the higher density associated therewith. As a result, the lamellar structures remain stable for a longer period. Particles present in the composition do not accumulate, as is otherwise customary, on the surface of the composition. This makes the compositions easy to bottle, without the particles floating after bottling or storage. The absence or the lower content of gas/air ensures that the composition can be bottled with greater precision. Furthermore, the composition comprises more surfactant per volume, so that the washing performance per volume is higher than with customary compositions.

In the present invention, the viscosity of a composition refers in each case to a value determined by way of a Brookfield HATDV II viscometer, spindle 2 at 20 rpm at 20° C.

The composition is in particular a body care, washing or cleaning agent. Body care, washing or cleaning agents within the meaning of the present invention include cosmetics, household cleaners, fabric softeners, laundry detergents, floor care agents, all-purpose cleaners, manual and automatic dishwashing agents, general laundry detergents, shampoos, shower gels and bubble baths. Preferably, they are a washing or cleaning agent.

Compared to methods described in the prior art, the method according to the invention allows freedom from air in the product, and thus improved product stability. As a result of a “one pass” production process, targeted uniform homogenization is made possible. Investment costs can be reduced, since the product formulation is based on a base recipe, which can be produced using a simple method. This base recipe, once produced, can then be used further for different products. This saves the storage of batches of end products that are not immediately sold. As a result, energy and production costs are decreased, while the capacity of existing machinery is increased.

It is particularly advantageous to carry out the process according to the invention under overpressure during the continuous differentiation. A pressure of at least 0.1 bar above normal pressure is considered overpressure. The overpressure prevents gases, and in particular air, from being entrained during the differentiation of the composition. In this way, a product is obtained that is more free from air than products stemming from a batch process. As a result, the composition can be dosed more reliably and precisely. Since less gas is present in the compositions according to the invention, these have a higher density than comparable compositions.

### Exemplary Embodiments

The quantity information in the exemplary embodiments is provided in % a.s., which is to say in % active substance. In all examples, the information is based on 100% of the end product.

In the batch process (Example 1, Example 2a), a stirrer made by Intermig was used for stirring at a speed of 30 to 40 revolutions per minute.

Water was charged in a batch kettle in each of the exemplary embodiments. The amount of water charged here is approximately 50% by weight to 60% by weight, based on 100% by weight of the end product. The selection of the exact amounts is part of the customary area of responsibility of a person skilled in the art and dependent on the desired end product. It should be noted that water may likewise be entrained with further added components. According to the invention, the content of water in the end product can be 60% by weight to 75% by weight.

1. Batch Process (Prior Art)

A liquid, surfactant-containing composition was produced in a conventional batch process. For this purpose, water was charged in a 35 m³ batch kettle. While stirring, 1.9% a.s. NaOH, 1% a.s. boric acid and 2% a.s. citric acid were added. After the added component had dissolved (after stirring for approximately 5 minutes), a complexing agent (diethylenetriamine penta(methylene phosphonic acid) in the form of the 7-sodium salt (DTPMP-7Na)) was added in an amount of 0.7% a.s. After a stirring time of approximately 5 minutes, 6.5% a.s. surfactants (2.0% a.s. non-ionic surfactant having 12 to 18 carbon atoms and 7 mol EO/mol, 4.0% a.s. linear alkylbenzene sulfonate having 10 to 13 carbon atoms, and 0.5% a.s. of a fatty acid having 12 to 18 carbon atoms and low odor) was added and stirred for another 15 minutes. Thereafter, another 8% a.s. of an anionic surfactant (alkyl ether sulfate comprising a C₁₂ chain) was added and incorporated by stirring (approximately 15 minutes). The temperature was approximately 55° C. to 60° C.

Afterwards, the aqueous solution was cooled to a temperature of approximately 30 to 32° C. Subsequently, 0.03% a.s. of a defoamer, 2% a.s. ethanol as the solvent, 0.1% a.s. of a preservative, and 0.35% a.s. brightener were added. After these were uniformly distributed, 0.2% perfume capsules, 1.1% a.s. perfume and 0.28% a.s. dye solutions were added and likewise incorporated. Afterwards, enzymes (1.16% a.s.), a saline solution (3% a.s.), a non-ionic surfactant (isotridecanol having 3 mol EO/mol) (2% a.s.) and microbeads (0.25% a.s.) were incorporated. The mixture thus obtained was thoroughly stirred and then bottled in the customary manner.

The air-containing product obtained in the conventional production method has a milky appearance. The density was 0.927 g/cm³. The density was measured by way of a pycnometer from Erichsen (model 290). The method complies with the requirements of DIN 53217 (ISO 2811-1) and the regulations cited therein. The measurement was carried out at a temperature of 23±0.5° C.

2. Method According to the Inventio

a) Production of the Base Recipe:

A surfactant-containing composition was produced in accordance with the method according to the invention. First, water was charged in a batch kettle. While stirring, NaOH (2.3% a.s.), boric acid (1.2% a.s.) and citric acid (2.4% a.s.) were added. After these had dissolved in the water, diethylenetriamine penta(methylene phosphonic acid) in the form of the 7-sodium salt (DTPMP-7Na) (0.85% a.s.) was added. Thereafter, surfactants (non-ionic surfactant having 12 to 18 carbon atoms and 7 mol EO/mol (2.4% a.s.), linear alkylbenzene sulfonate having 10 to 13 carbon atoms (4.8% a.s.), and a fatty acid having 12 to 18 carbon atoms and low odor (0.6% a.s.) were incorporated while stirring. After thorough stirring, another anionic surfactant (alkyl ether sulfate comprising a C₁₂ chain, 9.7% a.s.) was incorporated. The temperature was approximately 55° C. to 60° C.

After the mixture had cooled to a temperature of approximately 30 to 32° C., defoamers (0.04% a.s.), ethanol (2% a.s.) and preservatives (0.1% a.s.) were incorporated. This base recipe was produced as described for the known batch process (Example 1).

The viscosity of the base recipe was 750 mPa·s at 20° C. The viscosity was determined by way of a Brookfield HATDV II viscometer, spindle 2 at 20 rpm at 20° C.

b) Differentiation of the Base Recipe:

Thereafter, a portion of the base recipe was differentiated in a continuous process. For this purpose, the composition of the batch was pumped into a system of lines. The diameter of the main pipe was 65 mm. The flow velocity was in the range of 0.5 to 1.9 m/s. The pressure in the line system was 0.1 to 6 bar above normal pressure.

The main stream, which consists of the base recipe, was 82.7% of the end product. The following additives were dosed into this mean stream, which is to say into the base recipe, via side streams (again, the information refers to the amount present in the end product, wherein the end product corresponds to 100%):
brightener (0.35% solution in deionized water (0.035% a.s.))
perfume capsules (0.2% a.s.)
perfume (1.1% a.s.)
optionally NaOH
enzymes (1.16% as.)
dye solutions (0.28% a.s.)
NaCl solution (20% or 25% solutions in deionized water) (3% a.s.)
non-ionic surfactant (isotridecanol having 3 mol EO/mol) (2% a.s.)
microbeads (0.25% a.s.)

The air-free product thus produced in the method according to the invention had a higher density of 1.062 g/cm³. As indicated above, the determination was again carried out in a pycnometer in accordance with DIN 53127. The measurement was carried out at a temperature of 23±0.5° C. The viscosity was 1500 to 2500 mPa·s. The viscosity was determined by way of a Brookfield HATDV II viscometer, spindle 2 at 20 rpm at 20° C. The yield point of the composition was 2.1 Pa. Both composition 1) and composition 2b) included shell-core particles (microbeads), which were clearly visible as red dots in the composition. While the particles were floating after just a short time in the product containing air (Example 1, prior art) (because air deposits on these), these particles were uniformly distributed in the product in the air-free composition according to the invention (Example 2).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for producing a liquid, surfactant-containing composition having a yield point, the method comprising the steps of:
preparing a base recipe comprising at least one surfactant and at least one solvent in a batch process, and
differentiating the base recipe in a subsequent step in a continuous process.

2. The method according to claim 1, wherein the composition has a yield point in the range of 0.01 Pa to 50 Pa.

3. The method according to claim 2, wherein the yield point is in the range of 0.1 to 10 Pa.

4. The method according to claim 3, wherein the yield point is in the range of 0.5 Pa to 5 Pa.

5. The method according to claim 1, wherein the base recipe has a viscosity of 1000 mPa·s or less at 20° C.

6. The method according to claim 5, wherein the viscosity is determined by use of a Brookfield HATDV II viscometer, spindle 2 at 20 rpm. The method according to claim 5, wherein the viscosity is 200 to 800 mPa·s at 20° C. The method according to claim 7, wherein the viscosity is 400 to 700 mPa·s at 20° C.

9. The method according to claim 1 wherein the base recipe comprises builders and/or alkaline substances.

10. The method according to claim 1, wherein the continuous process is carried out at a pressure which is elevated above ambient pressure by 0.1 to 6 bar.

11. The method according to claim 10, wherein the continuous process is carried out at a pressure which is elevated above ambient pressure by 0.5 to 4 bar.

12. The method according to claim 1, wherein the differentiation takes place by adding one or more co-surfactants and/or one or more electrolytes, and wherein the content of co-surfactants and/or the electrolytes is up to 15% by weight of the composition.

13. The method according to claim 12, wherein the content of the co-surfactants and/or the electrolytes is up to 10% by weight of the composition.

14. The method according to claim 13, wherein the content of the co-surfactants and/or the electrolytes is up to 5% by weight of the composition.

15. The method according to claim 1, wherein dispersed particles are added for differentiation of the base recipe in the subsequent step.

16. The method according to claim 15, wherein the particles are visible particles.

17. The method according to claim 15, wherein the particles are microcapsules.

18. A liquid, surfactant-containing composition having a yield point prepared by the method according to claim 1.

19. The composition according to claim 18, wherein the composition has a viscosity at 20° C. of 50,000 mPa·s or less, wherein the viscosity is determined by way of a Brookfield HATDV II viscometer, spindle 2 at 20 rpm at 20° C.

20. The composition according to claim 18, wherein the composition is a body care, washing or cleaning agent.
